(19) United States
(12) Patent Application Publication
(10) Pub. No.: US 2012/0263983 A1
(43) Pub. Date: Oct. 18, 2012

(54) BATTERY MODULE

(76) Inventors: Jong-Wook YOON, Yongin-si (KR); Jeong-Deok Byun, Yongin-si (KR)

(21) Appl. No.: 13/345,015

(22) Filed: Jan. 6, 2012

(30) Foreign Application Priority Data
Apr. 12, 2011 (KR) 10-2011-0033774

(51) Int. Cl. H01M 2/02; H01M 2/12; H01M 10/50

(52) U.S. Cl. 429/82; 429/156; 429/120

(57) ABSTRACT

A battery module includes an outer case having a receiving space defined therein, an inner case having a cavity defined therein, the inner case being in the receiving space of the outer case, a plurality of unit battery packs in the cavity of the inner case, and an elastic buffer between the inner case and the outer case.

### BACKGROUND

1. Field

Embodiments relate to a battery module.

2. Description of the Related Art

Secondary batteries are applied to various industrial fields, and thus, may be widely used as energy sources in mobile electronic devices such as digital cameras, cellular phones, and laptop computers. Recently, secondary batteries have been highlighted as an energy source of hybrid electric vehicles that have been suggested for reducing air pollution caused by conventional gasoline and diesel internal-combustion engines using fossil fuel. The secondary battery may be packaged by being received in a pack case, and a plurality of secondary batteries may form a module according to a desired output capacity.

### SUMMARY

Embodiments are directed to a battery module.

According to one or more embodiments, a battery module may include an outer case having a receiving space defined therein, an inner case having a cavity defined therein, the inner case being in the receiving space of the outer case, a plurality of unit battery packs in the cavity of the inner case, and an elastic buffer between the inner case and the outer case.

The elastic buffer may elastically support the inner case on the outer case. The elastic buffer may separate the inner case by a predetermined distance from the outer case. The elastic buffer may be on a bottom frame of the outer case. The elastic buffer may include an elastic plate overlapping the bottom frame; and at least one supporting protrusion separating the elastic plate by a predetermined distance from the bottom frame.

The elastic plate may be formed of a steel material and include a plurality of openings. The elastic plate and the at least one supporting protrusion may be formed integrally with each other. The at least one supporting protrusion may be welded on the bottom frame.

The at least one supporting protrusion may include a first supporting protrusion extending from edges of the elastic plate toward the bottom frame, and a second supporting protrusion protruding from inner portions of the elastic plate toward the bottom frame, the inner portions being closer to a center of the elastic plate than the edges. The first supporting protrusion may include a plurality of first supporting protrusions formed in a line shape along sides of the elastic plate. The second supporting protrusion may include a plurality of second supporting protrusions formed symmetrically on left and right portions of the elastic plate. The second supporting protrusions may include an embossed surface of the elastic plate that extends toward the bottom frame.

A cooling fan module that induces air flow in the outer case may be mounted on a front portion of the outer case. The cooling fan module may be a unitary component that is detachably coupled with the outer case. The cooling fan module may be coupled with an opening in the front portion of the outer case, the cooling fan module forming an exterior portion of the battery module.

The battery module may further include gaps between side surfaces of the outer case and the inner case, the gaps directing air flow from the outer case. The side surfaces of the inner case may include a plurality of vent holes. The side surface of the inner case may include a coupling portion thereon.

The inner case may include a pair of opposing upper and lower sidewalls, and a pair of opposing upright sidewalls extending parallel to each other between the pair of upper and lower sidewalls, the upper and lower sidewalls may include vent holes extending therethrough. The vent holes may have a slit shape.

According to one or more embodiments of the present invention, a battery module may include an outer case having a receiving space defined therein, an inner case having a cavity defined therein, the inner case being in the receiving space of the outer case, a plurality of unit battery packs in the cavity of the inner case, an elastic buffer between the inner case and the outer case, the elastic buffer separating the inner case by a predetermined distance from a bottom surface of the outer case, and a cooling fan module mounted on an exterior portion of a front portion of the outer case.

### BRIEF DESCRIPTION OF THE DRAWINGS

The embodiments will become more apparent to those of ordinary skill in the art by describing in detail exemplary embodiments with reference to the attached drawings, in which:

FIG. 1 illustrates an exploded perspective view of a battery module according to an embodiment;

FIG. 2 illustrates an exploded perspective view of a battery case shown in FIG. 1;

FIG. 3 illustrates a perspective view of the battery case of FIG. 2 in an assembled state;

FIG. 4 illustrates a cross-sectional view of the battery case taken along line IV-IV of FIG. 2; and

FIG. 5 illustrates a cross-sectional view of the battery case taken along line V-V of FIG. 2.

### DETAILED DESCRIPTION

Korean Patent Application No. 10-2011-0033774, filed on Apr. 12, 2012, in the Korean Intellectual Property Office, and entitled: “Battery Module,” is incorporated herein by reference in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another element or substrate, it can be directly on the other element or substrate, or intervening elements may also be present. Further, it will be understood that when an element is referred to as being “under” another element, it can be directly under, and one or more intervening elements may also be present. In addition, it will also be understood that when an element is referred to as being “between” two elements, it can be the only element between the two elements, or one or more intervening elements may also be present. Like reference numerals refer to like elements throughout.

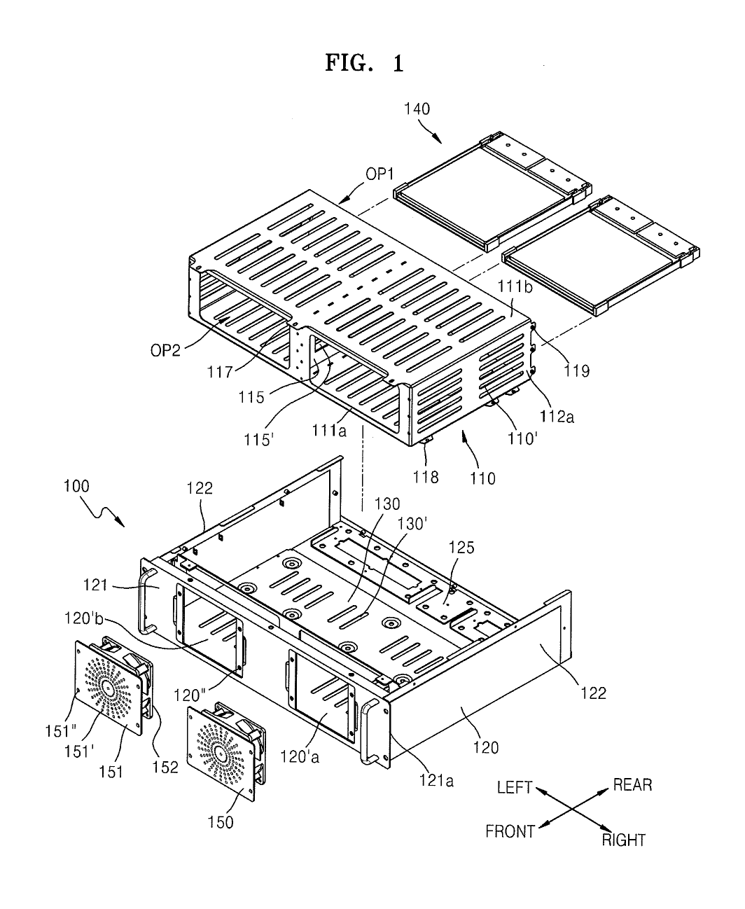

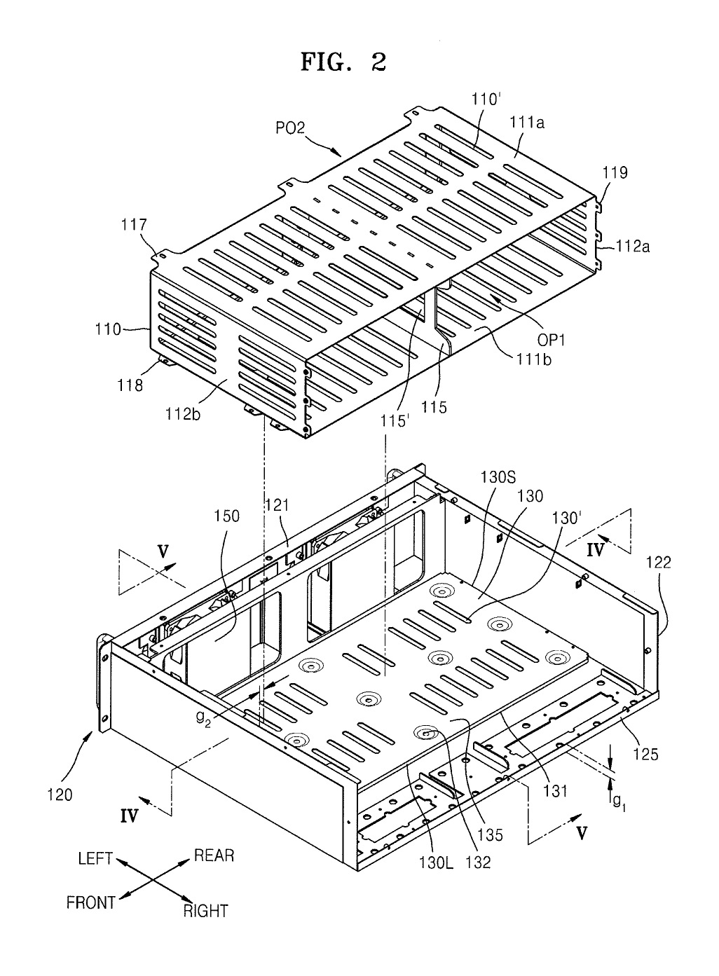

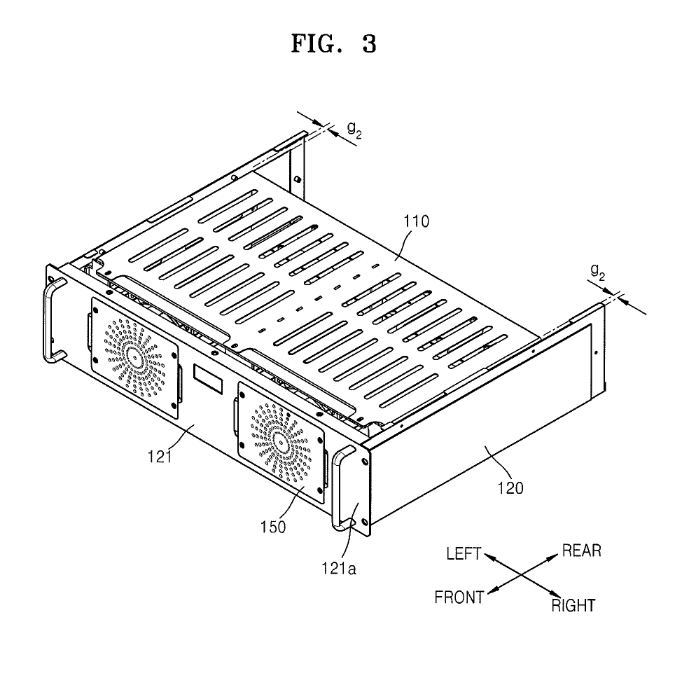

FIG. 1 illustrates an exploded perspective view of a battery module 100 according to an embodiment. FIG. 2 illustrates an exploded perspective view of a battery case that is a part of the battery module of FIG. 1. FIG. 3 illustrates a perspective view of the battery case of FIG. 2 in an assembled state.

Referring to FIGS. 1-3, the battery module 100 may include a plurality of unit battery packs 140 and battery cases 110 and 120 for receiving the unit battery packs 140. The battery cases 110 and 120 may provide receiving spaces for retaining the plurality of unit battery packs 140. An inner case 110 may receive a plurality of unit battery packs 140; and an outer case 120 may surround the inner case 110. The battery cases 110 and 120 may form a dual-case structure including the inner case 110 and the outer case 120.

The plurality of battery packs 140 may be stacked in the inner case 110. For example, each of the unit battery packs 140 may have flat upper and lower surfaces. The unit battery packs 140 may be positioned on top of each other to form a stack.

The inner case 110 may include an inner receiving space or cavity for receiving the unit battery packs 140. The inner case 110 may have a parallelepiped shape and the receiving space may be generally rectangular. The unit battery packs 140 may be received in the inner case 110 through an opening OP1 on a rear portion of the inner case 110. The battery pack 140 may be slid into the inner case 110 from the rear portion of the inner case 110 toward a front portion of the inner case 110. The plurality of unit battery packs 140 may be sequentially disposed in the inner case 110, one on top of the other, so as to form stacks of unit battery packs 140 in the inner case 110.

The inner case 110 may include a pair of opposing first upper and lower sidewalls 111a and 111b (extending parallel to each other), and a pair of opposing second upright sidewalls 112a and 112b (extending parallel to each other). The upright sidewalls 112a and 112b may extend between and connect the first upper and lower sidewalls 111a and 111b. The first upper and lower sidewalls 111a and 111b and the second upright sidewalls 112a and 112b may include a plurality of vent holes 110′, which are formed as elongated holes. For example, in the battery cases 110 and 120, air flow may be generated by a cooling fan module 150 on a front portion of the outer case 120. The air may flow back and forth between the front and rear of the inner case 110. The vent holes 110′ may be formed as elongated slits, longer sides of which are vertically aligned. External air at a low temperature may flow into the receiving space (in which the unit battery packs 140 are disposed) through the vent holes 110′. Heat in the battery cases 110 and 120 may be exhausted through the vent holes 110′.

In the inner case 110, at least two stacks or two columns of unit battery packs 140 may be positioned side-by-side to form a row of stacks of unit battery packs in the inner case 110. According to an embodiment, a barrier 115 may extend between two rows of stacked unit battery packs 140. The barrier 115 may partition the receiving space of the inner case 110 into two separate compartments. The barrier 115 may prevent movement of the unit battery packs 140. In addition, an open area 115′ may be formed in a center portion of the barrier 115, which may facilitate communication between the two separate compartments of the receiving space. The open area 115′ of the barrier 115 may contribute to heat dissipation. The inner case 110 may have a porous structure entirely, which may lessen the weight of the battery module 100. The plurality of vent holes 110′ may be formed in the upper and lower sidewalls 111a and 111b as well as the upright sidewalls 112a and 112b of the inner case 110. Openings OP1 and OP2 may extend between the upper and lower sidewalls 111a and 111b and the upright sidewalls 112a and 112b.

According to an embodiment, the opening OP2 may be formed in the front side of the inner case 110. A stopper (provided on the front side of the inner case 110) may partially block the opening OP2. For example, the opening OP2 may be partially open so that the air generated by the cooling fan module 150 may flow in, while dislocation or movement of the unit battery packs 140 out of the inner case 110 is prevented. The opening OP1 may be entirely open, or unblocked, on the rear side of the inner case 110. The plurality of unit battery packs 140 may be disposed in the inner case 110 through the rear side of the inner case 110, and may be blocked from escaping the inner case 110 through the front side. Thus, a position of the unit battery packs 140 in the inner case 110 may be maintained. However, embodiments are not limited to the specific configuration described above.

Coupling portions 117 and 118 may be disposed on at least a side of the inner case 110 to facilitate coupling with the outer case 120. The coupling portions 117 and 118 may facilitate engaging of the inner case 110 and the outer case 120 with each other. The coupling portions 117 and 118 may extend from sidewalls of the inner case (which contact the outer case 120) to facilitate mechanically coupling the inner case 110 with the outer case 120. For example, the coupling portions 117 and 118 may be flanges that extend from a lower sidewall 111a of the inner case 110 toward the outer case 120. In addition, coupling members (not shown) may penetrate through the coupling portions 117 and 118 and may be screwed into the outer case 120, thereby facilitating coupling of the inner case 110 and the outer case 120.

In an implementation, the coupling member (not shown) may be a bolt-nut assembly. The inner case 110 and the outer case 120 may be detachably coupled together. In an implementation, the inner case 110 and the outer case 120 may be integrally connected or coupled to each other through a permanent coupling method such as a welding.

The coupling portions may include one or more first coupling portions 117 (arranged along a front edge of the inner case 110, e.g., a front edge of upper sidewall 111b) and one or more second coupling portions 118 (arranged along a side edge of the inner case 110, e.g. a lower edge of first and/or second upright sidewalls 112a and 112b). The first coupling portions 117 may be coupled to a front frame 121 of the outer case 120.

The second coupling portions 118 may be formed along a lower side edge of the inner case 110, and may be coupled to a bottom frame 125 of the outer case 120. The first and second coupling portions 117 and 118 may be coupled to the outer case 120 via the coupling members (not shown), for example, bolts and nuts, or other fasteners, that may be screwed to the outer case 120 by penetrating through the first and second coupling portions 117 and 118.

In an implementation, third coupling portions 119 may be formed along a rear side edge, e.g., rear edge of first and/or second upright sidewalls 112a and 112b of the inner case 110. The third coupling portions 119 may be coupled to the outer case 120 or a back plate (not shown) on a rear portion of the inner case 110.

The inner case 110 may be received in a receiving space of the outer case 120. The outer case 120 may have a parallelepiped shape and the receiving space of the outer case 120 may be rectangular. The outer case 120 may include the front frame 121 (for receiving the cooling fan module 150) a bottom frame 125, and side wall frames 122. The front frame 121, the bottom frame 125, and the side frames 122 may surround the inner case 110.

In the present embodiment shown in FIGS. 1 through 3, an upper portion of the outer case 120 may be open; however, the outer case 120 may further include a cover frame (not shown) for covering the upper portion of the outer case 120 to seal the receiving space.

The cooling fan module 150 may be mounted on the front frame 121 of the outer case 120. The cooling fan module 150 may include a front panel 151, an opposing rear panel 152, and an interposing cooling fan (not shown) therebetween. The front panel 151 may include vent holes 151′ through which air may enter the outer case 120, and the rear panel 152 may also include vent holes (not shown) for exhausting air from the cooling fan (not shown). The cooling fan (not shown) may include blower wings (not shown); and a driving power may be applied to the cooling fan (not shown) through a power cable (not shown).

The front panel 151 may include coupling holes 151″ to facilitate coupling the cooling fan module 150 to the outer case 120. The cooling fan module 150 may be fixedly or detachably coupled with the outer case 120 by coupling members (not shown) that are coupled to the outer case 120 after penetrating through the coupling holes 151″.

At least two openings 120′a and 120′b, in which the cooling fan modules 150 are inserted, may be formed near opposing ends of the front frame 121 of the outer case 120. Coupling holes 120″ for coupling to the coupling members (not shown) may be formed around the openings 120′a and 120′b.

The cooling fan module 150 may be a kind of modulized assembling unit. As used with respect to the cooling fan module 150, the term “modulized” means that the coupled status of the front panel 151, the cooling fan (not shown), and the rear panel 152 is maintained when the battery cases 110 and 120 are assembled or even when the battery pack 100 is disassembled for maintenance. For example, the cooling fan module 150 may form a unitary component and may be detachably coupled with the battery cases 110 and 120 as one unit.

Workability in operations such as maintenance, re-assembling, or replacing of the cooling fan module 150 may be improved by modulizing the cooling fan module 150 as an assembling unit. Since the cooling fan module 150 may be assembled and disassembled as a module unit, the workability may also be improved.

As shown in FIG. 1, the cooling fan modules 150 may be coupled to both openings 120′a and 120′b of the outer case 120. The cooling fan module 150 may be inserted into the openings 120′ of the front frame 121. The coupling members (not shown) may be inserted in the cooling fan module 150 and screwed to the front frame 121. As such, the cooling fan module 150 may be coupled to an exterior or exposed surface of the front frame 121. Once the cooling fan module 150 is attached to the outer case 120, the cooling fan module 150 may extend from the front frame 121. Thus, there may be no need to disassemble the battery cases 110 and 120 when replacing the cooling fan module 150. Also, the cooling fan module 150 may be detachable from the front frame 121, outside of the battery cases 110 and 120.

Spacers 121a may be disposed on left and right sides of the front frame 121 and extend past opposing side frames 122. The spacers 121a may be formed as parts of the front frame 121, and may integrally extend from the front frame 121. Thus, a gap between the battery module 100 and a neighboring battery module may be maintained by the spacers 121a. In addition, thermal interference (which may be caused when two neighboring battery modules 100 are adhered to each other) may be prevented.

In an implementation, a plurality of battery modules 100 may be compiled in a limited space. Accordingly, an appropriate gap may be provided between the battery modules 100 by the spacers 121a, in order to prevent a chain heat transfer that may be initiated by overheating in one battery module 100.

An elastic buffer 130 may be disposed between the inner case 110 and the outer case 120. The elastic buffer 130 may elastically support the inner case 110 (e.g. bottom sidewall 111a of inner case 110) to absorb a shock transferred to the inner case 110 and to protect the unit battery packs 140 retained in the inner case 110. For example, the elastic buffer 130 may absorb the shock transferred from the outer case 120 and repeated vibrations generated during conveying and handling of the battery module 100. The elastic buffer 130 may block direct transfer of the shock to the inner case 110 that holds the unit battery packs 140.

In an implementation, a drop impact may be sustained by the unit battery packs 140 during handling of the battery packs 140. Repeated vibrations may also be generated during conveyance and/or transportation of the battery packs 140. The elastic buffer 130 may be disposed on a lower portion of the inner case 110. The inner case 110 may be elastically supported by the elastic buffer 130, e.g., may be elevated or separated from the bottom frame 125 of the outer case 120, without contacting or adhering to the outer case 120.

According to an embodiment, the elastic buffer 130 may be positioned on the outer case 120 in a space between the inner case 110 and the outer case 120. For example, the elastic buffer 130 may be fixed on the bottom frame 125 of the outer case 120, which faces the inner case 110. In addition, the elastic buffer 130 may protect the plurality of unit battery packs 140 received in the inner case 110 from damage due to external shock or vibrations by elastically supporting the inner case 110 with respect to the bottom frame 125 of the outer case 120.

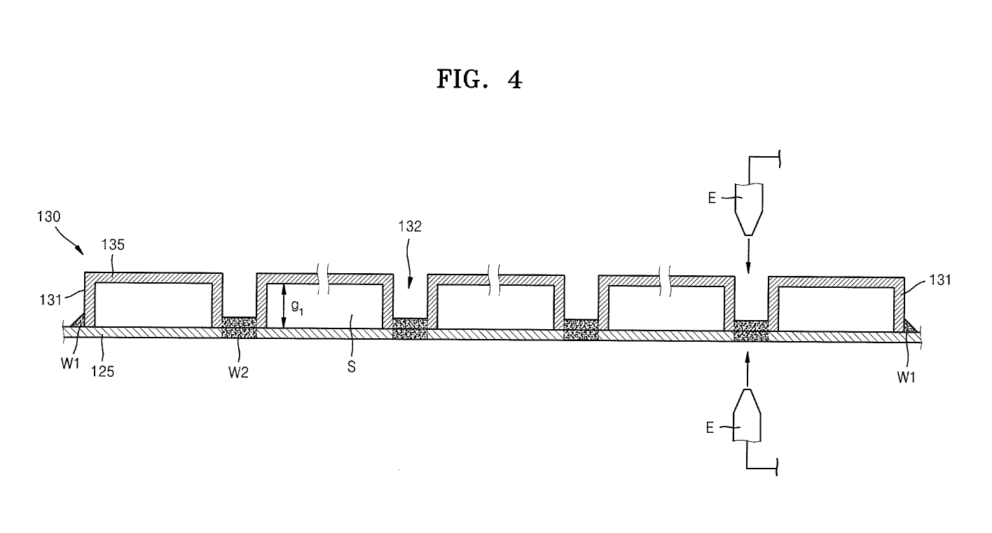

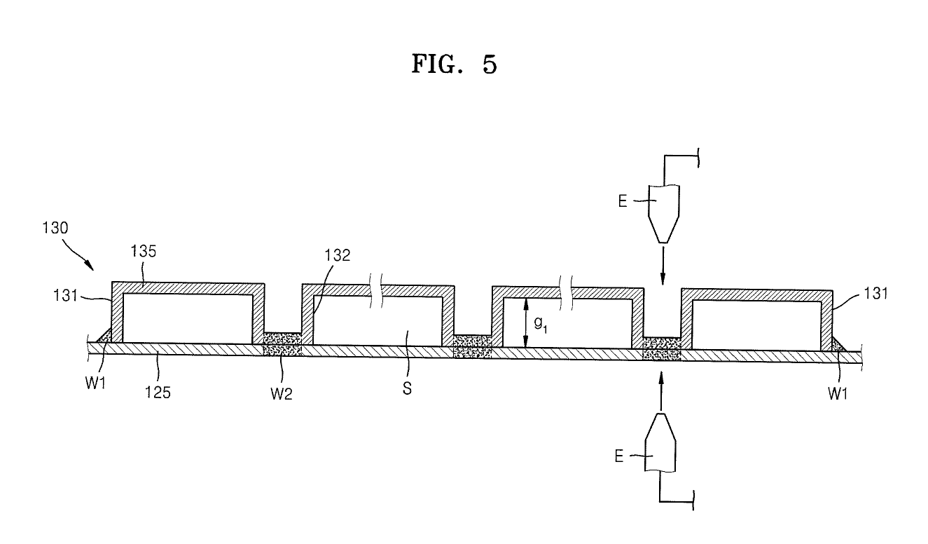

FIG. 4 illustrates a cross-sectional view of the elastic buffer 130 taken along line IV-IV of FIG. 2. FIG. 5 illustrates a cross-sectional view of the elastic buffer 130 taken along line V-V of FIG. 2. Referring to FIGS. 2, 4, and 5, the elastic buffer 130 may be formed as a plate shaped member that is disposed on the bottom frame 125 of the outer case 120. The elastic buffer may overlap the bottom frame 125. The elastic buffer 130 may include an elastic plate 135 that faces the bottom frame 125 of the outer case 120. A predetermined gap may be provided between the elastic plate 135 and the bottom frame 125; and a plurality of supporting protrusions 131 and 132 may extend from the elastic plate 135 and contact the bottom frame 125.

According to an embodiment, the elastic buffer 130 may be formed of a metal plate or other suitable material that provides the inner case 110 with some degree of mechanical rigidity, as well as a shock-absorbing property. The plurality of supporting protrusions 131 and 132 may be formed on the metal plate. For example, the supporting protrusions 131 and 132 may be integrally formed through a pressing or a bending process. The elastic buffer 130 may be formed of steel or other suitable metal having shock-absorbing property. However, embodiments are not limited to the above example. For example, the elastic buffer 130 may include various other elastic materials. According to an embodiment, the elastic plate 135 and the supporting protrusions 131 and 132 may be formed of different materials and may be coupled to each other to form the elastic buffer 130.

As shown in FIGS. 4 and 5, the elastic plate 135 may be separated from the bottom frame 125 by a predetermined gap g1. The gap g1 may accept or facilitate a curve-distortion of the elastic buffer 130, and the shock/vibrations may be absorbed through the distortion of the elastic buffer 130. The gap g1 between the elastic buffer 130 (the elastic plate 135) and the bottom frame 125 of the outer case 120 may be large enough to accept or compensate for the curvature of the elastic buffer 130 in the distorted state.

The supporting protrusions 131 and 132 may support the elastic plate 135 on the bottom frame 125 to maintain the gap g1 between the elastic plate 135 and the bottom frame 125. The supporting protrusions 131 and 132 may include first supporting protrusions 131 extending from edges of the elastic plate 135, and second supporting protrusions 132 extending from various portions of a bottom surface of the elastic plate 135 toward the bottom frame 125. The first supporting protrusions 131 may be a continuous strip formed along edges of the elastic plate 135, or a plurality of independent pieces dispersed throughout the bottom surface of the elastic plate 135.

The first supporting protrusion 131 may extend downwardly along an outer perimeter of the elastic plate 135 and contact the bottom frame 125. As shown in FIG. 2, the first supporting protrusions 131 may be formed in a line shape along four side edges of the elastic plate 135, e.g., along edges of longer sides 130L and shorter sides 130S of the elastic plate 135. The first supporting protrusions 131 may provide a stable support for the elastic plate 135 so that the weight of the elastic plate 135 may be evenly distributed thereon. The first supporting protrusions 131 may be formed symmetrically or evenly along the edges of the four sides 130L and 130S of the elastic plate 135 to stably support the elastic plate 135.

As shown in FIGS. 4 and 5, the second supporting protrusions 132 may protrude from an inner area of the elastic plate 135, e.g., spaced from the edges of the elastic plate 135, toward the bottom frame 125 and contact the bottom frame 125. The second supporting protrusions 132 may be formed by embossing the bottom surface of the elastic plate 135 through a pressing process, so that portions of the bottom surface of the elastic plate appear raised or embossed on one side and depressed on another side. The second supporting protrusion 132 may be press-welded against the bottom frame 125 through a spot welding process. A part of the elastic plate 135 may be compressed toward the bottom frame 125 by a welding-electrode E so that the embossed shape of the second supporting protrusion 132 may be naturally formed. In this case, forming and welding of the second supporting protrusions 132 may be simultaneously performed. Thus, the procedure for forming the second supporting protrusions 132 may not need to be performed in a separate process. Each of the second supporting protrusions 132 may protrude from the inner portions of the elastic plate 135 and may be spaced or isolated from other second supporting protrusions 132. The second supporting protrusions 132 may contact the bottom frame 125 and support the elastic plate 135 thereon. The second supporting protrusions 132 may be formed symmetrically in the elastic plate 135, and thereby, may stably support the elastic plate 135.

The first and second supporting protrusions 131 and 132 may be fixed on the bottom frame 125 by a mechanical coupling method, or in a permanent coupling method, such as welding. For example, as shown in FIGS. 4 and 5, the first and second supporting protrusions 131 and 132 may be welded on the bottom surface 125. That is, the first supporting protrusions 131 may be fixed on the bottom frame 125 through a seam welding process, along the edges of the elastic plate 135, and the second supporting protrusions 132 may be fixed on the bottom frame 125 through a spot welding process on inner portions of the elastic plate 135. However, embodiments are not limited to the above welding process, and various welding methods may be used.

For example, the first supporting protrusions 131 may be fixed on the bottom frame 125 by performing the spot welding process on a plurality of points along edges of the elastic plate 135. In FIGS. 4 and 5, reference numeral W1 denotes a fillet welding portion between the first supporting protrusion 131 and the bottom frame 125, and reference numeral W2 denotes a spot welding portion between the second supporting protrusion 132 and the bottom frame 125. However, embodiments are not limited thereto.

The plurality of second supporting protrusions 132 may be formed in the elastic plate 135. Thus, the elastic plate 135 may provide a desired degree of elasticity. The second supporting protrusions 132 may protrude from the elastic plate 135 toward the bottom frame 125, and thereby elevate or separate the unit battery packs 140 from the bottom frame 125. The supporting protrusions may avoid or prevent an excessive curvature of the elastic plate 135 (which may degrade the shock absorbing property of the elastic plate 135) and adherence of the elastic plate 135 to the bottom frame 125.

As shown in FIG. 2, the elastic plate 135 may include a plurality of openings 130′, and the openings 130′ may contribute to heat dissipation of the unit battery packs 140 and/or may contribute to ensuring an appropriate elastic coefficient of the elastic plate 135. A range of the appropriate elastic coefficient may be achieved to sufficiently attenuate external shock and, at the same time, have a certain degree of rigidity so that the unit battery packs 140 do not collide with the outer case 120.

According to an embodiment, the elastic plate 135 may have a certain degree of rigidity because the elastic plate 135 may support the inner case 110 (which retains the plurality of unit battery packs 140) in an elevated position. On the other hand, if the elastic plate 135 is excessively rigid, absorbing of shock through curvature of the elastic plate 135, may not be achieved. Thus, the elastic coefficient of the elastic plate 135 may be set accordingly. In an implementation, the elastic plate 135 may be formed of steel and may include a plurality of openings 130′.

According to an embodiment, an outer surface of the inner case 110 and an inner surface of the outer case 120 may be partially separated from each other, e.g., have at least some points of direct contact. According to an embodiment, the inner case 110 and the outer case 120 may face each other, or be coupled together, without directly contacting each other e.g., have no points of direct contact. In other words, the surfaces of the inner and outer cases 110 and 120 may be completely separate from each other. For example, at least the bottom frame 125 of the outer case 120 and the lower sidewall 111a of the inner case 110 may be separated from each other, as described above, by the elastic buffer 130 disposed between the inner and outer cases 110 and 120. The elastic buffer 130 may, thereby, absorb shock/vibrations to protect the unit battery packs 140 retained in the inner case 110. As shown in FIGS. 2 and 3, the upright sidewalls 112a and 112b of the inner case 110 and the side frames 122 of the outer case 120 may also be separated from each other. As described above, the second coupling portions 118 may be disposed on the side edges of the inner case 110, and coupled to the bottom frame 125 of the outer case 120. The coupling members (not shown) may penetrate through the second coupling portions 118 and be screwed to the bottom frame 125, thereby forming predetermined gaps g2 between the upright sidewalls 112a and 112b and side frame 122 for performing the coupling operation of the coupling members (not shown), for example, the screwing operation.

In addition, the gaps g2 formed between the inner case 110 and the outer case 120 may provide a flow path for heat dissipation. Cooler air blown by the cooling fan modules 150 (installed on the front portion of the battery cases 110 and 120) may provide a thermal transfer medium for the unit battery packs 140 while flowing from the front portion toward the rear portion of the battery cases 110 and 120. When the flow paths (corresponding to the gaps g2) are provided along the sides of the inner case 110, cooler air may flow through the flow paths, and thus, heat dissipating efficiency of the unit battery packs 140 retained in the inner case 110 may be improved.

The upright sidewalls 112a and 112b of the inner case 110 facing the flow paths (the gaps g2) may include vent holes 110′ for facilitating thermal interchange between cooler air and the unit battery packs 140. The side frames 122 of the outer case 120 facing the flow paths may be blocked so as not to exhaust the air and prevent a flow resistance to the air.

According to embodiments, a bottom surface the inner case 110 and the outer case 120 may not be adhered to each other, e.g., the lower sidewall 111a of the inner case 110 and the bottom frame 125 of the outer case 120 may be separated by the elastic buffer 130 disposed between the inner and outer case 110 and 120. As such, external shock/vibrations from the outer case 120 may not be directly transferred to the unit battery packs 140 retained in the inner case 110. In addition, the gaps g2 (formed between the side surfaces of the inner and outer cases 110 and 120) facilitate coupling between the inner and outer cases 110 and 120 and provide a flow path for air to improve the heat dissipating efficiency.

According to one or more embodiments, the battery case receiving the plurality of battery packs may have a dual compartment structure, and a vibration absorbing structure. Thus, the vibration resistance of the battery module including the plurality of battery packs in the battery case may be improved. Further, an anti-shock characteristic of the battery module may also improved.

In addition, according to one or more embodiments, the cooling fan module for cooling the plurality of battery packs received in the battery case may be assembled, disassembled, and replaced as a unitary component. Therefore, the workability in the assembling or maintenance of the cooling fan module may be improved.

One or more embodiments of the present invention include a battery module having improved anti-shock and vibration resistance characteristics.

One or more embodiments of the present invention also include a battery module having an improved workability in assembling and maintaining operations.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery module, comprising:
an outer case having a receiving space defined therein; and
an inner case having a cavity defined therein, the inner case being in the receiving space of the outer case;
a plurality of unit battery packs in the cavity of the inner case;
an elastic buffer between the inner case and the outer case.

2. The battery module as claimed in claim 1, wherein the elastic buffer elastically supports the inner case on the outer case.

3. The battery module as claimed in claim 1, wherein the elastic buffer separates the inner case by a predetermined distance from the outer case.

4. The battery module as claimed in claim 1, wherein the elastic buffer is on a bottom frame of the outer case.

5. The battery module as claimed in claim 4, wherein the elastic buffer includes:
an elastic plate overlapping the bottom frame; and
at least one supporting protrusion separating the elastic plate by a predetermined distance from the bottom frame.

6. The battery module as claimed in claim 5, wherein the elastic plate is formed of a steel material and includes a plurality of openings.

7. The battery module as claimed in claim 5, wherein the elastic plate and the at least one supporting protrusion are formed integrally with each other.

8. The battery module as claimed in claim 5, wherein the at least one supporting protrusion is welded on the bottom frame.

9. The battery module as claimed in claim 5, wherein the at least one supporting protrusion includes:
a first supporting protrusion extending from edges of the elastic plate toward the bottom frame; and
a second supporting protrusion protruding from inner portions of the elastic plate toward the bottom frame, the inner portions being closer to a center of the elastic plate than the edges.

10. The battery module as claimed in claim 9, wherein the first supporting protrusion includes a plurality of first supporting protrusions formed in a line shape along sides of the elastic plate.

11. The battery module as claimed in claim 9, wherein the second supporting protrusion includes a plurality of second supporting protrusions formed on symmetrically left and right portions of the elastic plate.

12. The battery module as claimed in claim 9, wherein the second supporting protrusion includes an embossed surface of the elastic plate that extends toward the bottom frame.

13. The battery module as claimed in claim 1, wherein a cooling fan module that induces air flow in the outer case is mounted on a front portion of the outer case.

14. The battery module as claimed in claim 13, wherein the cooling fan module is a unitary component, the cooling fan being detachably coupled with the outer case.

15. The battery module as claimed in claim 13, wherein the cooling fan module is coupled with an opening in the front portion of the outer case, the cooling fan module forming an exterior portion of the battery module.

16. The battery module as claimed in claim 13, further including gaps between side surfaces of the outer case and the inner case, the gaps directing air flow from the outer case.

17. The battery module as claimed in claim 16, wherein the side surfaces of the inner case include a plurality of vent holes.

18. The battery module as claimed in claim 16, wherein the side surface of the inner case includes a coupling portion thereon.

19. The battery module as claimed in claim 13, wherein the inner case includes:
a pair of opposing upper and lower sidewalls; and
a pair of opposing upright sidewalls extending parallel to each other between the pair of upper and lower sidewalls,
wherein the upper and lower sidewalls include vent holes extending therethrough, the vent holes having a slit shape.

20. A battery module, comprising:
an outer case having a receiving space defined therein;
an inner case having a cavity defined therein, the inner case being in the receiving space of the outer case;
a plurality of unit battery packs in the cavity of the inner case;
an elastic buffer between the inner case and the outer case, the elastic buffer separating the inner case by a predetermined distance from a bottom surface of the outer case; and
a cooling fan module mounted on an exterior portion of a front portion of the outer case.
